(19) United States
(12) Patent Application Publication
(10) Pub. No.: US 2023/0078912 A1
(43) Pub. Date: Mar. 16, 2023

(54) SYSTEMS AND METHODS FOR MOLDING POLYMERIC STRUCTURES

(71) Applicant: Richard Sofia, Troy, OH (US)

(72) Inventor: Richard Sofia, Troy, OH (US)

(21) Appl. No.: 17/473,611

(22) Filed: Sep. 13, 2021

(51) Int. Cl. E01C 9/08; B29C 45/14; B29C 45/00; E01C 5/20

(52) U.S. Cl. CPC E01C 9/086; B29C 45/14467; B29C 45/0053; E01C 5/20; B29L 2031/7324

(57) ABSTRACT

A polymeric structure includes a first polymeric component and a second polymeric component, the first polymeric component including a first mating surface and an opposing first free surface and the second polymeric component including a second mating surface and an opposing second free surface. The first polymeric component and the second polymeric component are positioned with the first mating surface facing the second mating surface. A charge of molten polymer is disposed between the first mating surface and the second mating surface. A compressive force is applied to the first free surface of the first polymeric component and to the second free surface of the second polymeric component in order to secure the first polymeric component to the second polymeric component in order to form the polymeric structure. The polymeric structure may be a construction mat.

### TECHNICAL FIELD

The present disclosure pertains to systems and methods for molding polymeric structures. More particularly, the present disclosure relates to systems and methods for molding polymeric structures from multiple previously formed sub-components.

### BACKGROUND

A wide variety of systems and methods are known for molding polymeric structures. Of the known systems and methods, each has certain advantages and disadvantages. There is an ongoing need to provide alternative systems and methods for molding polymeric structures.

### SUMMARY

This disclosure provides systems and methods for molding polymeric structures. In an example, a polymeric structure may be molded from a first polymeric component and a second polymeric component, the first polymeric component including a first mating surface and an opposing first free surface and the second polymeric component including a second mating surface and an opposing second free surface. The first polymeric component and the second polymeric component are positioned with the first mating surface facing the second mating surface and a charge of molten polymer is disposed between the first mating surface and the second mating surface. A compressive force is applied to the first free surface of the first polymeric component and to the second free surface of the second polymeric component in order to secure the first polymeric component to the second polymeric component in order to form the polymeric structure.

Alternatively or additionally, the first polymeric component may be formed prior to manufacturing the polymeric structure.

Alternatively or additionally, the second polymeric component may be formed prior to manufacturing the polymeric structure.

Alternatively or additionally, the first polymeric component may be at or close to ambient temperature when positioned relative to the second polymeric component.

Alternatively or additionally, the second polymeric component may be at or close to ambient temperature when positioned relative to the first polymeric component.

Alternatively or additionally, the compressive force to the first free surface of the first polymeric component and to the second free surface of the second polymeric component may be maintained until the charge of molten polymer solidifies.

Alternatively or additionally, the method may further include forming a channel within at least one of the first mating surface and the second mating surface and disposing the charge of molten polymer between the first mating surface and the second mating surface comprises disposing the charge of molten polymer into the channel.

Alternatively or additionally, forming a channel may include forming a first channel portion in the first mating surface and a corresponding second channel portion in the second mating surface and disposing the charge of molten polymer between the first mating surface and the second mating surface may include disposing the charge of molten polymer into the first channel portion and into the second channel portion.

Alternatively or additionally, the first channel portion and the second channel portion may be configured such that the molten polymer, once solidified, forms a locking member within the first channel portion and the second channel portion that secures the first polymeric component to the second polymeric component.

Alternatively or additionally, applying a compressive force to the first free surface of the first polymeric component and to the second free surface of the second polymeric component may include applying a compressive force without applying any heat apart from residual heat from the charge of molten polymer.

Alternatively or additionally, the first polymeric component may be injection molded.

Alternatively or additionally, the second polymeric component may be injection molded.

Alternatively or additionally, the first mating surface may include first component mating features, the second mating surface may include second component mating features that are complementary to the first component mating features and the first component mating features may mate with the second component mating features when the first polymeric component and the second polymeric component are positioned with the first mating surface facing the second mating surface.

Alternatively or additionally, the first component mating features may include male mating features and the second component mating features may include complementary female mating features.

Alternatively or additionally, the polymeric structure may include a construction mat quadrant.

Alternatively or additionally, the first polymeric component may include a top half of the construction mat quadrant.

Alternatively or additionally, the second polymeric component may include a bottom half of the construction mat quadrant.

Alternatively or additionally, the first polymeric component and the second polymeric component may each be configured to include additional features that allow the construction mat quadrant to be secured to other construction mat quadrants to form a construction mat.

In another example, a construction mad quadrant may be molded from a top mat component and a bottom mat component, the top mat component including a first mating surface and a first free surface and the bottom mat component including a second mating surface and a second free surface. The top mat component and the bottom mat component are positioned with the first mating surface facing the second mating surface and a charge of molten polymer is disposed between the first mating surface and the second mating surface. A compressive force is applied to the first free surface of the top mat component and to the second free surface of the bottom mat component in order to secure the top mat component to the bottom mat component in order to form the construction mat quadrant.

Alternatively or additionally, the top mat component may be formed prior to manufacturing the construction mat quadrant.

Alternatively or additionally, the bottom mat component may be formed prior to manufacturing the construction mat quadrant.

Alternatively or additionally, the top mat component may be at or close to ambient temperature when positioned relative to the bottom mat component.

Alternatively or additionally, the bottom mat component may be at or close to ambient temperature when positioned relative to the top mat component.

Alternatively or additionally, the compressive force to the first free surface of the top mat component and to the second free surface of the bottom mat component may be maintained until the charge of molten polymer solidifies.

Alternatively or additionally, the method may further include forming a channel within at least one of the first mating surface and the second mating surface and disposing the charge of molten polymer between the first mating surface and the second mating surface comprises disposing the charge of molten polymer into the channel.

Alternatively or additionally, forming a channel may include forming a first channel portion in the first mating surface and a corresponding second channel portion in the second mating surface and disposing the charge of molten polymer between the first mating surface and the second mating surface may include disposing the charge of molten polymer into the first channel portion and into the second channel portion.

Alternatively or additionally, the first channel portion and the second channel portion may be configured such that the molten polymer, once solidified, forms a locking member within the first channel portion and the second channel portion that secures the top mat component to the bottom mat component.

Alternatively or additionally, applying a compressive force to the first free surface of the top mat component and to the second free surface of the bottom mat component may include applying a compressive force without applying any heat apart from residual heat from the charge of molten polymer.

Alternatively or additionally, the top mat component may be injection molded.

Alternatively or additionally, the bottom mat component may be injection molded.

Alternatively or additionally, the first mating surface may include first component mating features, the second mating surface comprises second component mating features that are complementary to the first component mating features and the first component mating features may mate with the second component mating features when the top mat component and the bottom mat component are positioned with the first mating surface facing the second mating surface.

Alternatively or additionally, the first component mating features may include male mating features and the second component mating features may include complementary female mating features.

In another example, a construction mat quadrant includes an injection molded top mat component including a first mating surface and an injection molded bottom mat component including a second mating surface in opposition with the first mating surface. A first locking channel is formed within the first mating surface and a second locking channel is formed within the second mating surface. A polymeric locking member extends through the first locking channel and the second locking channel and prevents the top mat component from moving relative to the bottom mat component.

Alternatively or additionally, the first mating surface may include a plurality of first mating features.

Alternatively or additionally, the second mating surface may include a plurality of second mating features that are configured to accommodate the plurality of first mating features.

Alternatively or additionally, the plurality of first mating features may engage with the plurality of second mating features in order to help secure the injection molded top mat component to the injection molded bottom mat component.

In another example, a method of manufacturing a construction mat includes forming four construction mat quadrants and assembling the four construction mat quadrants to form a construction mat. Forming each of the construction mat quadrants includes positioning a top mat component and a bottom mat component with a first mating surface of the top mat component facing a second matting surface of the bottom mat component and disposing a charge of molten polymer between the first mating surface and the second mating surface. A compressive force is applied to the top mat component and to the bottom mat component in order to secure the top mat component to the bottom mat component in order to form the construction mat quadrant.

Alternatively or additionally, the top mat component for each construction mat quadrant may be formed prior to manufacturing the construction mat.

Alternatively or additionally, the bottom mat component for each construction mat quadrant may be formed prior to manufacturing the construction mat.

Alternatively or additionally, each top mat component may be at or close to ambient temperature when positioned relative to the corresponding bottom mat component.

Alternatively or additionally, each bottom mat component may be at or close to ambient temperature when positioned relative to the corresponding top mat component.

Alternatively or additionally, the compressive force to the each top mat component and to each bottom mat component may be maintained until the corresponding charge of molten polymer solidifies.

Alternatively or additionally, forming one of the construction mat quadrants may further include forming a channel within at least one of the first mating surface and the second mating surface and disposing the charge of molten polymer between the first mating surface and the second mating surface comprises disposing the charge of molten polymer into the channel.

Alternatively or additionally, forming a channel may include forming a first channel portion in the first mating surface and a corresponding second channel portion in the second mating surface and disposing the charge of molten polymer between the first mating surface and the second mating surface may include disposing the charge of molten polymer into the first channel portion and into the second channel portion.

Alternatively or additionally, the first channel portion and the second channel portion may be configured such that the molten polymer, once solidified, forms a locking member within the first channel portion and the second channel portion that secures the top mat component to the bottom mat component.

Alternatively or additionally, applying a compressive force to each top mat component and to each bottom mat component may include applying a compressive force without applying any heat apart from residual heat from the corresponding charge of molten polymer.

Alternatively or additionally, at least some of the top mat components may be injection molded.

Alternatively or additionally, at least some of the bottom mat components may be injection molded.

Alternatively or additionally, the first mating surface may include first component mating features, the second mating surface may include second component mating features that are complementary to the first component mating features and the first component mating features may mate with the second component mating features when the top mat component and the bottom mat component are positioned with the first mating surface facing the second mating surface.

Alternatively or additionally, the first component mating features may include male mating features and the second component mating features may include complementary female mating features.

In another example, a construction mat includes four construction mat quadrants that are secured together. Each of the four construction mat quadrants include an injection molded top mat component including a first mating surface and an injection molded bottom mat component including a second mating surface in opposition with the first mating surface. A first locking channel is formed within the first mating surface and a second locking channel is formed within the second mating surface. A polymeric locking member extends through the first locking channel and the second locking channel and prevents the top mat component from moving relative to the bottom mat component.

Alternatively or additionally, for each construction mat quadrant, the corresponding first mating surface may include a plurality of first mating features.

Alternatively or additionally, for each construction mat quadrant, the second mating surface may include a plurality of second mating features that are configured to accommodate the plurality of first mating features.

Alternatively or additionally, for each construction mat quadrant, the plurality of first mating features may engage with the plurality of second mating features in order to help secure the injection molded top mat component to the injection molded bottom mat component.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a schematic block diagram showing a pair of polymeric components being pressed together in a press;

FIG. 2 is a schematic top view of a polymeric component such as one of the pair of polymeric components of FIG. 1;

FIG. 3A is a schematic cross-sectional view of the polymeric components of FIG. 2, taken along line 3-3 of FIG. 2;

FIG. 3B is another schematic cross-sectional view of the polymeric components of FIG. 2, corresponding to line 3-3 of FIG. 2;

FIG. 4 is a schematic cross-sectional view of a polymeric structure formed from the pair of polymeric components shown in FIG. 1;

FIG. 5 is a flow diagram showing an illustrative method of forming a polymeric structure from a first polymeric component and a second polymeric component;

FIG. 6 is a flow diagram showing an illustrative method of forming a polymeric structure from a first polymeric component and a second polymeric component;

FIG. 7 is a flow diagram showing an illustrative method of forming a construction mat;

FIG. 8 is a flow diagram showing an illustrative method of forming a construction mat quadrant;

FIG. 9 is a flow diagram showing an illustrative method of forming a construction mat;

FIG. 10 is a perspective view showing an upper surface of a top construction mat component;

FIG. 11 is a perspective view showing a lower surface of the top construction mat component shown in FIG. 10;

FIG. 12 is a perspective view showing a lower surface of a bottom construction mat component;

FIG. 13 is a perspective view showing an upper surface of the bottom construction mat component shown in FIG. 12;

FIG. 14 is a perspective view showing the top construction mat component shown in FIGS. 10 and 11 being aligned with and joined with the bottom construction mat component shown in FIGS. 12 and 13; and

FIG. 15 is a schematic top view of a construction mat formed by assembling four construction mat quadrants.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

A number of polymeric structures may be formed from two (or more) distinct polymeric components that may be individually formed and then subsequently joined together to form the polymeric structure. In some cases, the polymeric structure may be too large or complex to mold as a single component. In some cases, individual polymeric components may be injection molded, for example. Other molding processes are contemplated. In some cases, individual polymeric components may be 3D printed. In some cases, the polymeric structure may be formed via a cold molding system in which already formed parts are remade into a new structure, such as the polymeric structure.

In some cases, a cold molding system can reduce or even eliminate the bolting, welding or gluing that may otherwise be used in joining two or more parts or materials together. A cold molding system may result in a stronger overall structure that will be at least as strong as any of the individual parts or materials.

A cold molding system joins together two (or more) polymeric components (e.g., components that are previously made and that are at or close to ambient temperature. A charge may be applied between the two (or more) polymeric components. In some cases, one or more thin lines may be ground or otherwise formed in the facing surfaces of the two (or more) polymeric components to be joined together. The location of the one or more thin lines may correspond to where the charge will be placed. In some cases, there may not be any thin lines ground or otherwise formed, and the charge can be placed in any desired location regardless of whether there are any grooves or thin lines.

In some cases, the charge may be heated, and thus is molten polymer that may be the same or different than the polymer(s) used to form each of the polymeric components being joined together. In some cases, the molten polymeric charge may be heated to a temperature of about 204° C. (400° F.). In some cases, parts of the two (or more) polymeric components where the charge is to be placed, such as the aforementioned thin ground lines, may be heated to improve chemical bonding. While any of a variety of different polymers may be used in forming each of the polymeric components, in some cases polyethylene or polypropylene may be used. Heating, if done, may involve heating an area of each polymeric component to be joined to a temperature that is about the same as the melting point of polyethylene or polypropylene. The melting point of polyethylene can range from about 110° C. for low density polyethylene to roughly 120° C. to 130° C. for medium and high density polyethylene. The melting point for polypropylene can range from about 130° C. to 171° C.

After the charge has been placed, compressive forces can be applied to the two (or more) polymeric components while the molten polymeric charge cools and solidifies, thereby securing together the two (or more) polymeric components to form the desired polymeric structure. It will be appreciated that the relative amount of the charge may be adjusted depending on tolerances and clearances between the two (or more) polymeric components being joined. In some cases, the two (or more) polymeric components may be made of dissimilar polymers, and a cold molding system may permit these components to be mechanically locked together. In some cases, if the two (or more) polymeric components are made of similar (or identical) polymers, a cold molding system may permit these components to be chemically bonded together. Each of the polymeric components may be molded to have any desired shape or surface textures, such as flat, smooth or grainy, for example.

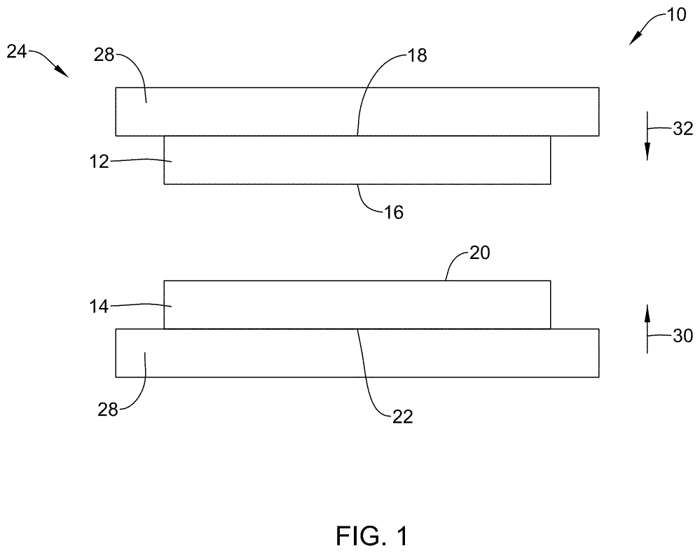

FIG. 1 is a schematic block diagram of a cold molding system 10. In this example, a first polymeric component 12 and a second polymeric component 14 are to be joined together to form a desired polymeric structure. It will be appreciated that the first polymeric component 12 has a first mating surface 16 and a first free surface 18 while the second polymeric component 14 has a second mating surface 20 and a second free surface 22. The first polymeric component 12 and the second polymeric component 14 are positioned such that the first mating surface 16 faces the second mating surface 20.

The first polymeric component 12 and the second polymeric component 14 can be seen as being disposed within a press 24 that includes a first plate 26 and a second plate 28. The press 24 may include appropriate hydraulics (not shown) that are configured to push the first plate 26 towards the second plate 28 in a direction indicated by an arrow 30 and/or push the second plate 28 towards the first plate 26 in a direction indicated by an arrow 32. In some cases, the first polymeric component 12 may be bolted or otherwise secured to the first plate 26. The second polymeric component 14 may be bolted or otherwise secured to the second plate 28. As a result, the first polymeric component 12 and the second polymeric component 14 may be considered as acting as a mold for any additional components that may be disposed between the first polymeric component 12 and the second polymeric component 14.

While the first polymeric component 12 and the second polymeric component 14 are schematically shown as rectilinear, it will be appreciated that this is merely illustrative, as the first polymeric component 12 and the second polymeric component 14 may take any of a variety of different straight or curved shapes. Regardless of the overall shapes of the first polymeric component 12 and the second polymeric component 14, the first mating surface 16 and the second mating surface 20, if not planar, are generally complementary to each other so that they can be joined together. It will be appreciated that while the first plate 26 and the second plate 28 of the press 24 are shown as rectilinear, the first plate 26 and the second plate 28 may take any of a variety of shapes that are complementary to the first free surface 18 and the second free surface 22, respectively, such that the first plate 26 is able to provide a compressive force to the first free surface 18 and the second plate 28 is able to provide a compressive force to the second free surface 22.

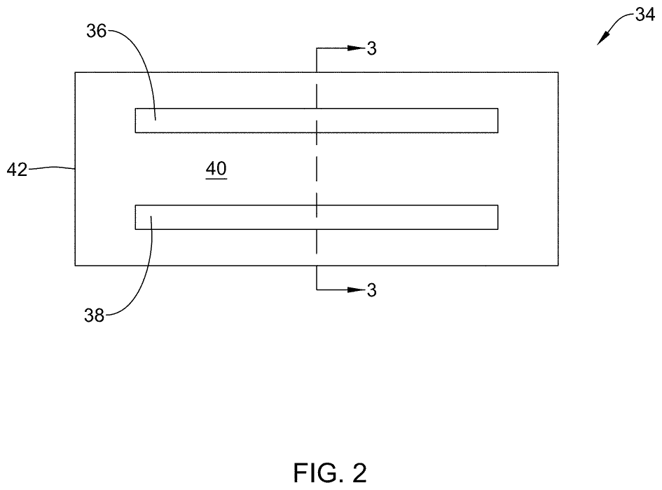

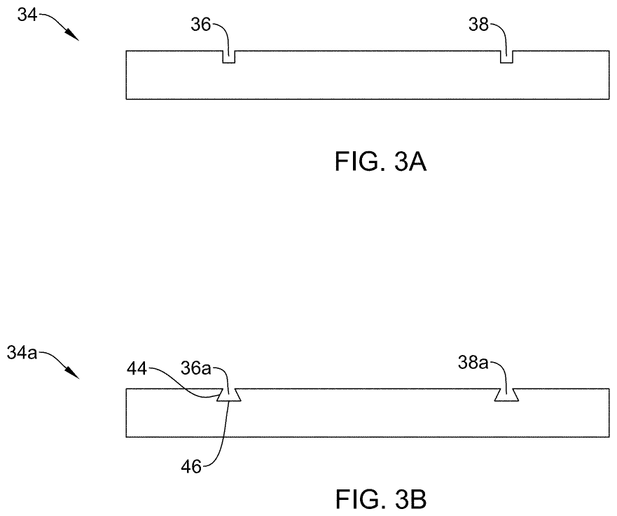

FIG. 2 is a top view of a polymeric component 34 that may be considered as being an example of the first polymeric component 12 or the second polymeric component 14 while FIG. 3 is a cross-sectional view of the polymeric component 34 taken along the line 3-3 of FIG. 2. As shown, the polymeric component 34 may include a first groove 36 and/or a second groove 38. The first groove 36 and the second groove 38 may be parallel to each other, as shown. In some cases, the first groove 36 and the second groove 38 may instead be non-parallel and may intersect each other. The first groove 36 and the second groove 38 may be formed in only one of the first polymeric component 12 and the second polymeric component 14, or the first groove 36 and the second groove 38 may be formed in both the first polymeric component 36 and the second polymeric component 14, for example.

While a pair of grooves 36 and 38 are shown, it will be appreciated that this is merely illustrative. In some cases, the polymeric component 34 may have only a single groove. In some cases, the polymeric component 34 may have three, four or more grooves. The groove(s) may be located within an interior 40 of the polymeric component 34, as shown. In some cases, the groove(s) may be located along a periphery 42 of the polymeric component 34. The groove(s) may correspond to where the polymeric charge is placed when joining the first polymeric component 12 and the second polymeric component 14 together in the cold molding system 10. In some cases, the polymeric component 34 may have be free of grooves (e.g., there may not be any grooves). In such cases, the polymeric charge may be placed at a suitable location along the polymer component 34.

As shown in FIG. 3A, the first groove 36 and the second groove 38 may have a simple rectilinear cross-sectional profile, as may result if the first groove 36 and the second groove 38 were formed using a saw blade, for example. In some cases, the first groove 36 and the second groove 38 may take other forms. In FIG. 3B, a polymeric component 34a may be seen as including a first groove 36a and a second groove 38a that have a cross-sectional profile in which an upper portion 44 of the first groove 36a (or the second groove 38a) has a smaller opening than a bottom 46 of the first groove 36a. It will be appreciated that a molten polymeric charge, when placed into the first groove 36a and the second groove 38a, will be locked into place within the first groove 36a and the second groove 38a when the molten polymeric charge cools and solidifies.

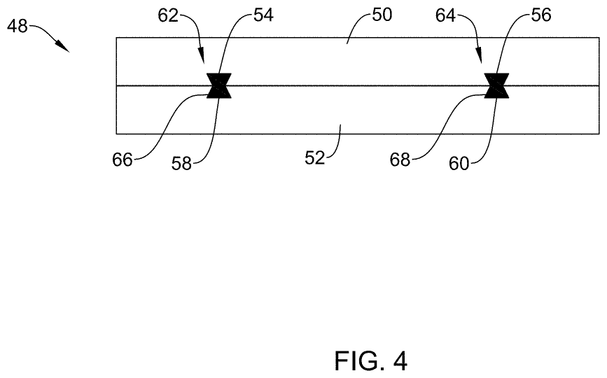

FIG. 4 is a schematic cross-sectional view of a polymeric structure 48 that is formed by joining together a first polymeric component 50 and a second polymeric component 52. The first polymeric component 50 may be considered as being an example of the first polymeric component 12 while the second polymeric component 52 may be considered as being an example of the second polymeric component 14. As shown, the first polymeric component 50 includes a first groove 54 and a second groove 56 that each have a profile similar to the first groove 36a and the second groove 38a. The second polymeric component 52 includes a first groove 58 that aligns with the first groove 54 (of the first polymeric component 50) and a second groove 60 that aligns with the second groove 56 (of the first polymeric component 50). The first groove 58 and the second groove 60 each have a profile similar to the first groove 36a and the second groove 38a.

The first groove 54 and the first groove 58 together form a first locking channel 62. The second groove 56 and the second groove 60 together form a second locking channel 64. The charge disposed within the first locking channel 62 has cooled and solidified into a first polymeric locking member 66. The charge disposed within the second locking channel 64 has cooled and solidified into a second polymeric locking member 68. It will be appreciated that the first polymeric locking member 66 and the second polymeric locking member 68 serve to secure the first polymeric component 50 to the second polymeric component 52 to form the polymeric structure 48.

In some cases, no other securement techniques or methods are needed to secure the first polymeric member 50 to the second polymeric member 52. In some cases, additional techniques such as adhesives may be used. In some cases, additional mechanical securements such as bolts or screws may also be used. These are just examples.

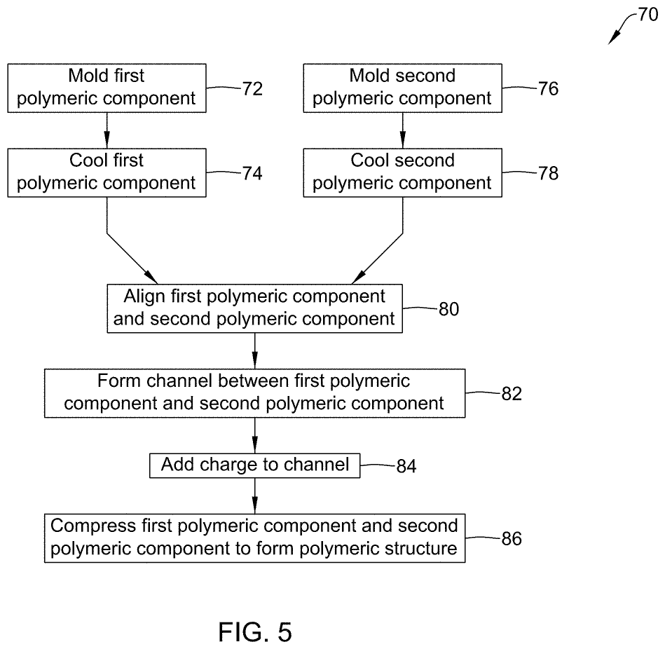

FIG. 5 is a flow diagram showing an illustrative method 70 of forming a polymeric structure from a first polymeric component and a second polymeric component. The first polymeric component may be molded, as indicated at block 72. This may entail molding a single first polymeric component. In some cases, a plurality of first polymeric components may be molded, intended for producing a plurality of polymeric structures. The first polymeric component, or the plurality thereof, are allowed to cool, as indicated at block 74. The second polymeric component may be molded, as indicated at block 76. This may entail molding a single second polymeric component. In some cases, a plurality of second polymeric components may be molded, intended for producing a plurality of polymeric structures. The second polymeric component, or the plurality thereof, are allowed to cool, as indicated at block 78.

A first polymeric component may be aligned with a second polymeric component, as indicated at block 80. This may include aligning the first polymeric component and the second polymeric component such that a mating surface of the first polymeric component aligns with a corresponding mating surface of the second polymeric component. A channel is formed between the first polymeric component and the second polymeric component, as indicated at block 82. This may entail forming a single channel, or a plurality of channels, either in both the first polymeric component and the second polymeric component, or only in one of the first polymeric component and the second polymeric component. A charge is added to the channel(s), as indicated at block 84. The first polymeric component and the second polymeric component are compressed together to form the polymeric structure, as indicated at block 86. In some cases, a compressive force is applied at least until the charge cools and solidifies.

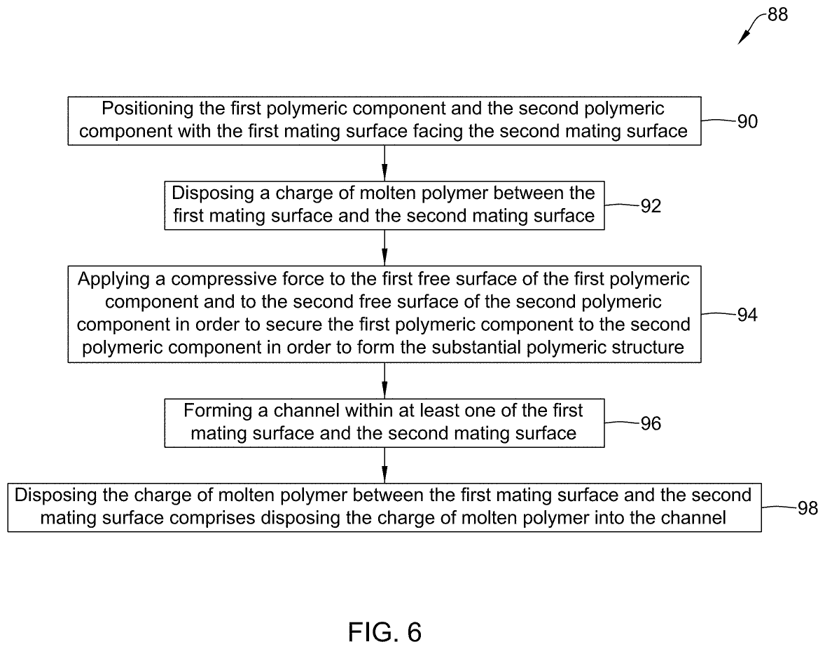

FIG. 6 is a flow diagram showing an illustrative method 88 of forming a polymeric structure including a first polymeric component and a second polymeric component, the first polymeric component including a first mating surface and an opposing first free surface and the second polymeric component including a second mating surface and an opposing second free surface. The first polymeric component and the second polymeric component are positioned with the first mating surface facing the second mating surface, as indicated at block 90. In some cases, the first polymeric component is formed prior to manufacturing the polymeric structure, such as via injection molding. In some cases, the second polymeric component is formed prior to manufacturing the polymeric structure, such as via injection molding. The first polymeric component may be at or close to ambient temperature when positioned next to the second polymeric component. The second polymeric component may be at or close to ambient temperature when positioned next to the first polymeric component.

A charge of molten polymer is deposited between the first mating surface and the second mating surface, as indicated at block 92. A compressive force is applied to the first free surface of the first polymeric component and to the second free surface of the second polymeric component in order to secure the first polymeric component to the second polymeric component in order to form the polymeric structure, as indicated at block 94. In some cases, the compressive force to the first free surface of the first polymeric component and to the second free surface of the second polymeric component is maintained until the charge of molten polymer solidifies. In some cases, applying a compressive force to the first free surface of the first polymeric component and to the second free surface of the second polymeric component may include applying a compressive force without applying any heat apart from residual heat from the charge of molten polymer

In some cases, the method 88 further includes forming a channel within at least one of the first mating surface and the second mating surface, as indicated at block 96. In some cases, deposing the charge of molten polymer between the first mating surface and the second mating surface may include disposing the charge of molten polymer into or onto the channel, as indicated at block 98. In some cases, forming a channel includes forming a first channel portion in the first mating surface and a corresponding second channel portion in the second mating surface and disposing the charge of molten polymer between the first mating surface and the second mating surface may include disposing the charge of molten polymer into the first channel portion and into the second channel portion. In some cases, the first channel portion and the second channel portion are configured such that the molten polymer, once solidified, forms a locking member within the first channel portion and the second channel portion that secures the first polymeric component to the second polymeric component.

In some cases, the first mating surface of the first polymeric component includes first component mating features and the second mating surface of the second polymeric component includes second component mating features that are complementary to the first component mating features. The first component mating features may mate with the second component mating features when the first polymeric component and the second polymeric component are positioned with the first mating surface facing the second mating surface. In some cases, the first component mating features include male mating features and the second component mating features include complementary female mating features.

In some cases, the polymeric structure is a construction mat quadrant, where four construction mat quadrants may be assembled together to form a construction mat. The first polymeric component may, for example, be a top half of a construction mat quadrant. The second polymeric component may, for example, be a bottom half of a construction mat quadrant. Joining the top half of the construction mat quadrant to the bottom half of the construction mat quadrant via a cold molding system results in a construction mat. In some cases, the first polymeric component and the second polymeric component are each configured to include additional features that allow the construction mat quadrant to be secured to other construction mat quadrants to form a construction mat.

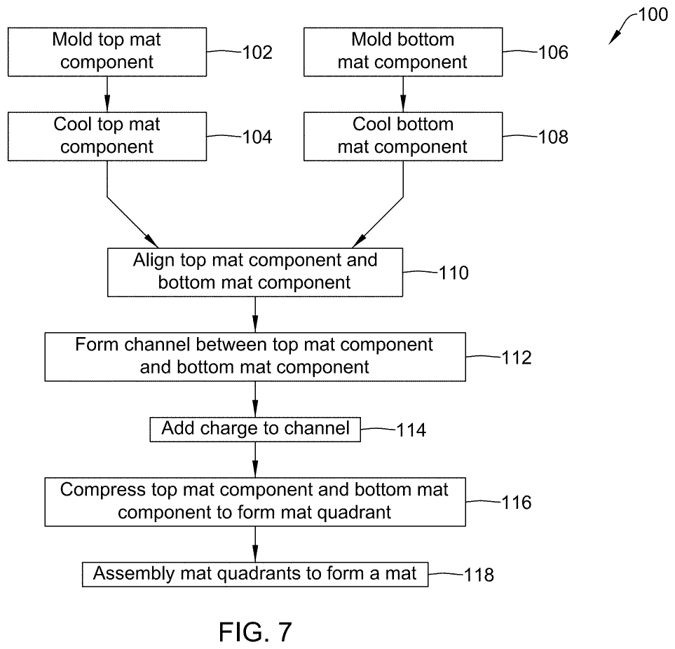

FIG. 7 is a flow diagram showing an illustrative method 100 of forming a construction mat from a top mat component and a bottom mat component. The top mat component may be molded, as indicated at block 102. This may entail molding a single top mat component. In some cases, a plurality of top map components may be molded, intended for producing a plurality of construction mats. The top mat component, or the plurality thereof, are allowed to cool, as indicated at block 104. The bottom mat component may be molded, as indicated at block 106. This may entail molding a single bottom mat component. In some cases, a plurality of bottom mat components may be molded, intended for producing a plurality of construction mats. The bottom mat component, or the plurality thereof, are allowed to cool, as indicated at block 108.

A top mat component may be aligned with a bottom mat component, as indicated at block 110. This may include aligning the top mat component and the bottom mat component such that a mating surface of the top mat component aligns with a corresponding mating surface of the bottom mat component. A channel is formed between the top mat component and the bottom mat component, as indicated at block 112. This may entail forming a single channel, or a plurality of channels, either in both the top mat component and the bottom mat component, or only in one of the top mat component and the bottom mat component. A charge is added to the channel(s), as indicated at block 114. The top mat component and the bottom mat component are compressed together to form the construction mat, as indicated at block 116. In some cases, a compressive force is applied at least until the charge cools and solidifies. Once the construction mat quadrants have been formed via a cold molding process, the construction mat quadrants are joined together in sets of four to form construction mats, as indicated at block 118.

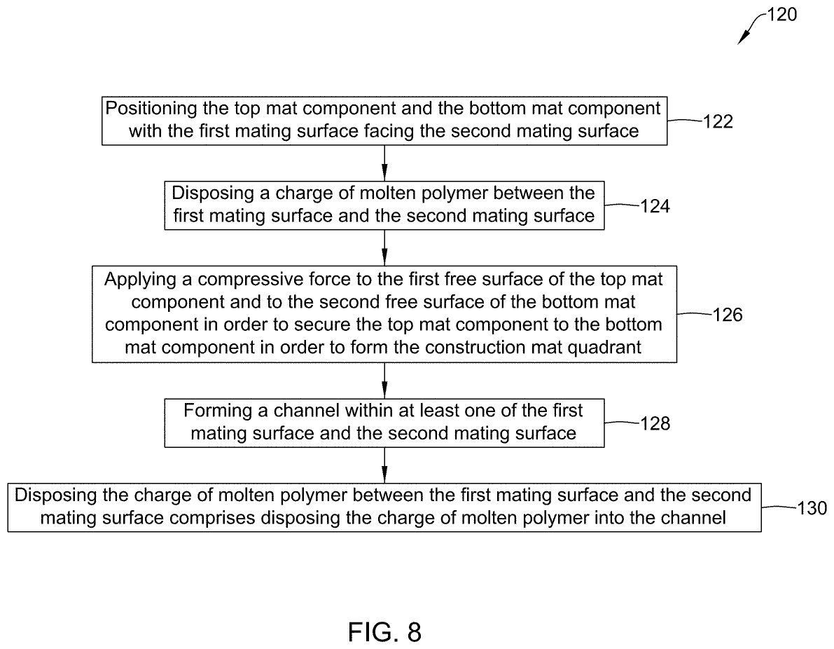

FIG. 8 is a flow diagram showing an illustrative method 120 of manufacturing a construction mat quadrant including a top mat component and a bottom mat component, the top mat component including a first mating surface and a first free surface and the bottom mat component including a second mating surface and a second free surface. The top mat component and the bottom mat component are positioned with the first mating surface facing the second mating surface, as indicated at block 122. The top mat component may be formed, such as via injection molding, prior to manufacturing the construction mat quadrant. The bottom mat component may be formed, such as via injection molding, prior to manufacturing the construction mat quadrant. The top mat component may be at or close to ambient temperature when positioned relative to the bottom mat component. The bottom mat component may be at or close to ambient temperature when positioned relative to the top mat component.

A charge of molten polymer is disposed between the first mating surface and the second mating surface, as indicated at block 124. A compressive force is applied to the first free surface of the top mat component and to the second free surface of the bottom mat component in order to secure the top mat component to the bottom mat component in order to form the construction mat quadrant, as indicated at block 126. The compressive force to the first free surface of the top mat component and to the second free surface of the bottom mat component may be maintained until the charge of molten polymer solidifies. In some cases, applying a compressive force to the first free surface of the top mat component and to the second free surface of the bottom mat component may include applying a compressive force without applying any heat apart from residual heat from the charge of molten polymer.

In some cases, the method 120 may also include forming a channel within at least one of the first mating surface and the second mating surface, as indicated at block 128. In some cases, disposing the charge of molten polymer between the first mating surface and the second mating surface may include disposing the charge of molten polymer into the channel, as indicated at block 130. In some cases, forming a channel may include forming a first channel portion in the first mating surface and a corresponding second channel portion in the second mating surface and disposing the charge of molten polymer between the first mating surface and the second mating surface may include disposing the charge of molten polymer into the first channel portion and into the second channel portion. In some cases, the first channel portion and the second channel portion are configured such that the molten polymer, once solidified, forms a locking member within the first channel portion and the second channel portion that secures the top mat component to the bottom mat component.

In some cases, the first mating surface includes first component mating features and the second mating surface includes second component mating features that are complementary to the first component mating features. In some cases, the first component mating features mate with the second component mating features when the top mat component and the bottom mat component are positioned with the first mating surface facing the second mating surface. As an example, the first component mating features may include male mating features and the second component mating features may include complementary female mating features.

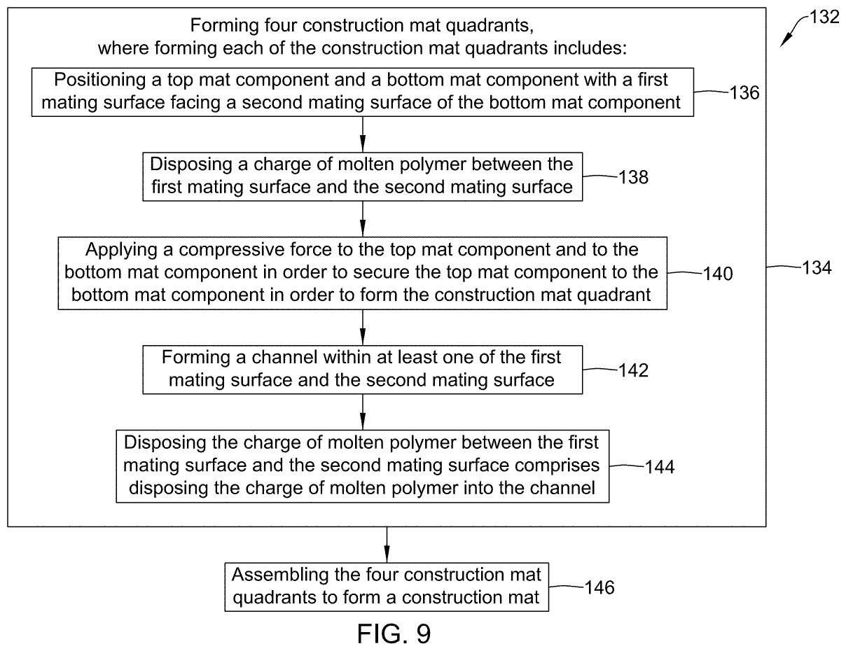

FIG. 9 is a flow diagram showing an illustrative method 132 of manufacturing a construction mat. Four construction mat quadrants are formed, as indicated at block 134. Forming each of the construction mat quadrants includes positioning a top mat component and a bottom mat component with a first mating surface of the top mat component facing a second matting surface of the bottom mat component, as indicated at block 136. A charge of molten polymer is disposed between the first mating surface and the second mating surface, as indicated at block 138. A compressive force is applied to the top mat component and to the bottom mat component in order to secure the top mat component to the bottom mat component in order to form the construction mat quadrant, as indicated at block 140. In some cases, the compressive force to the each top mat component and to each bottom mat component may be maintained until the corresponding charge of molten polymer solidifies. In some cases, applying a compressive force to each top mat component and to each bottom mat component may include applying a compressive force without applying any heat apart from residual heat from the corresponding charge of molten polymer

In some cases, the method 132 includes forming a channel within at least one of the first mating surface and the second mating surface, as indicated at block 142. In some cases, disposing the charge of molten polymer between the first mating surface and the second mating surface may include disposing the charge of molten polymer into the channel, as indicated at block 144. The four construction mat quadrants may then be assembled to form a construction mat, as indicated at block 146.

In some cases, forming a channel may include forming a first channel portion in the first mating surface and a corresponding second channel portion in the second mating surface and disposing the charge of molten polymer between the first mating surface and the second mating surface may include disposing the charge of molten polymer into the first channel portion and into the second channel portion. The first channel portion and the second channel portion may be configured such that the molten polymer, once solidified, forms a locking member within the first channel portion and the second channel portion that secures the top mat component to the bottom mat component.

In some cases, the top mat component for each construction mat quadrant may be formed prior to manufacturing the construction mat. At least some of the top mat components may be formed via injection molding. In some cases, the bottom mat component for each construction mat quadrant may be formed prior to manufacturing the construction mat. At least some of the bottom mat components may be formed via injection molding. In some cases, each top mat component may be at or close to ambient temperature when positioned relative to the corresponding bottom mat component. In some cases, each bottom mat component may be at or close to ambient temperature when positioned relative to the corresponding top mat component.

In some cases, the first mating surface includes first component mating features and the second mating surface includes second component mating features that are complementary to the first component mating features. The first component mating features may mate with the second component mating features when the top mat component and the bottom mat component are positioned with the first mating surface facing the second mating surface. In some cases, the first component mating features may include male mating features and the second component mating features may include complementary female mating features.

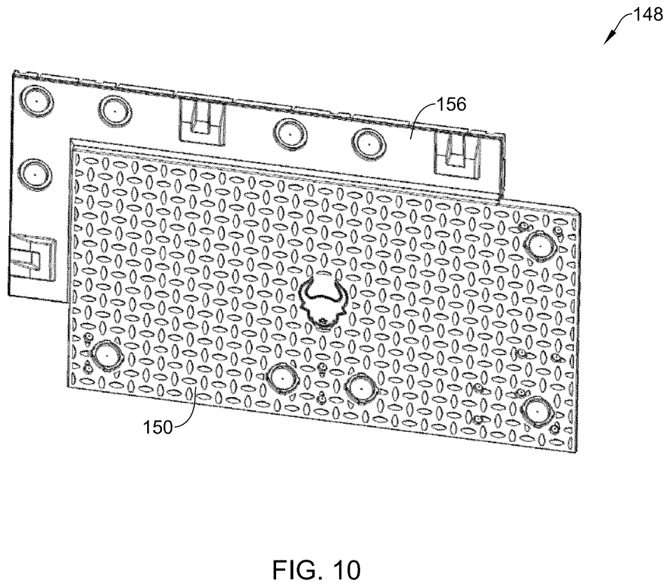

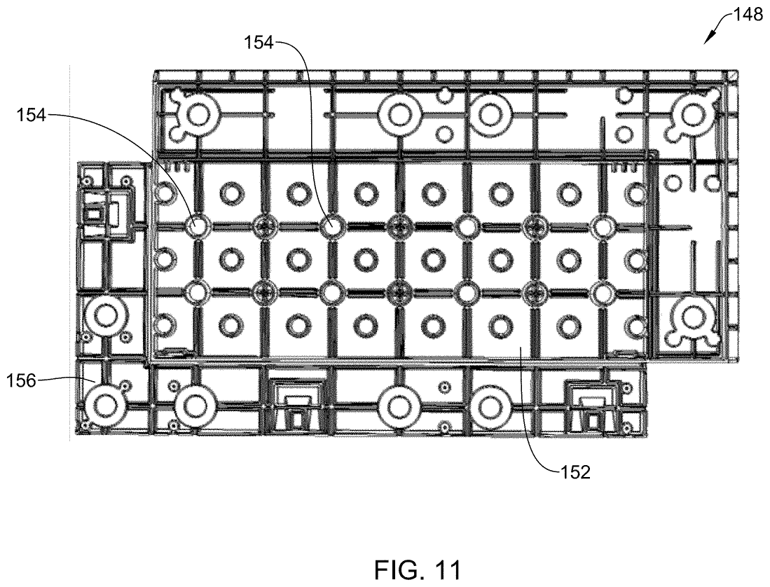

FIG. 10 is a perspective view of an upper portion of a top mat component 148 and FIG. 11 is a perspective view of a corresponding lower portion of the top mat component 148. The top mat component 148 includes an upper working surface 150 that will ultimately form the upper work surface of the construction mat that will be formed using the top mat component 148. The upper work surface corresponds to the surface that will be driven on, for example. The top mat component 148 includes a lower surface 152 that will abut a corresponding bottom mat component. It will be appreciated that the upper working surface 150 corresponds to the first free surface 18 of the first polymeric component 12 and the lower surface 152 corresponds to the first mating surface 16 of the first polymeric component 12 as shown in FIG. 1.

The lower surface 152 of the top mat component 148 includes a number of mating features 154 that will align with complementary mating features on the bottom mat component. In some cases, the mating features 154 may be considered to be male mating features, but this is not required in all cases. The top mat component 148 also includes a flange 156 by which construction mat quadrants are joined together to form a construction mat.

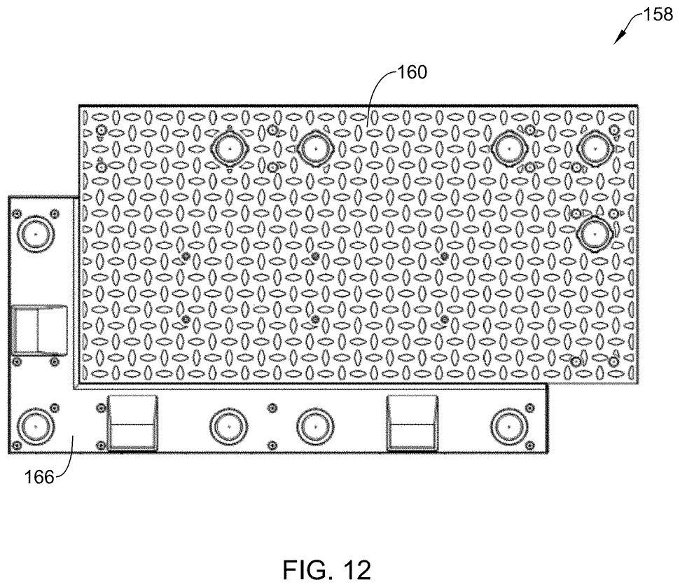

FIG. 12 is a perspective view of an upper portion of a bottom mat component 158 and FIG. 12 is a perspective view of a corresponding lower portion of the bottom mat component 158. The bottom mat component 158 includes a working surface 160 that will ultimately form the lower work surface of the construction mat that will be formed using the bottom mat component 158. The lower work surface corresponds to the surface that will abut whatever material the construction mat is placed on. The bottom mat component 158 includes an upper surface 162 that will abut the corresponding lower surface 152 of the top mat component 148. It will be appreciated that the working surface 160 corresponds to the second free surface 22 of the second polymeric component 14 and the upper surface 162 corresponds to the second mating surface 18 of the second polymeric component 14 as shown in FIG. 1.

The upper surface 162 of the bottom mat component 158 includes a number of mating features 164 that will align with the mating features 154 on the top mat component 148. In some cases, the mating features 164 may be considered to be female mating features, but this is not required in all cases. In some cases, a male mating feature such as one of the mating features 154 fit into a corresponding female mating feature such as one of the mating features 164. The bottom mat component 158 also includes a flange 166 that aligns with the flange 156.

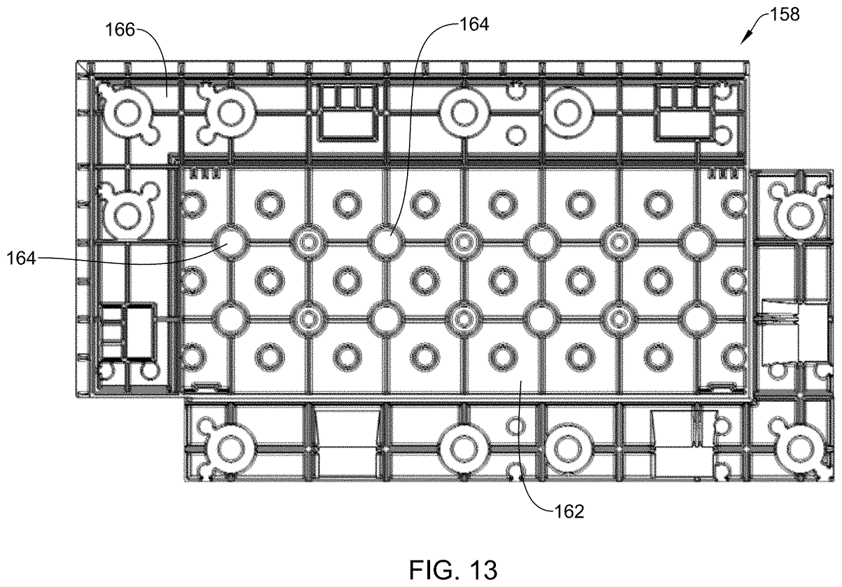

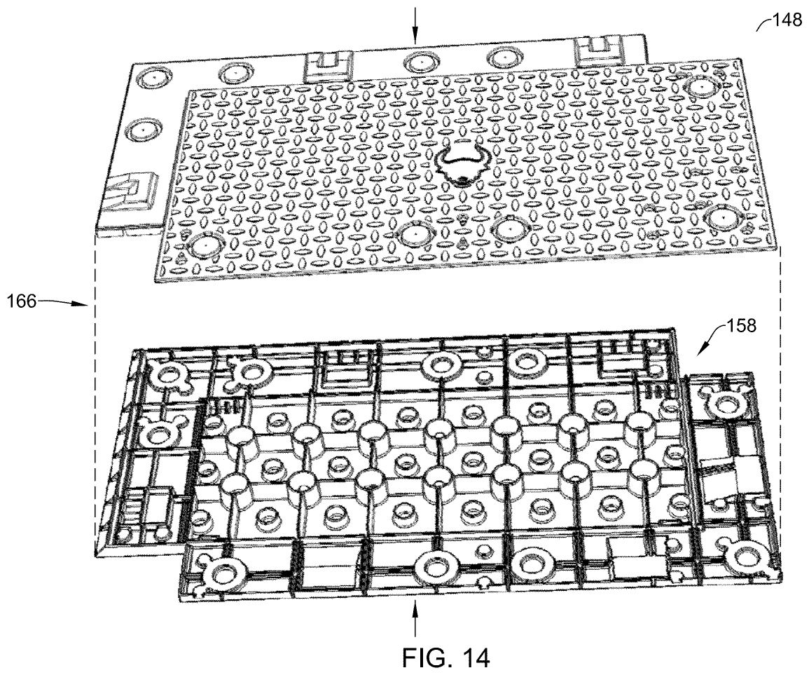

FIG. 14 is a perspective view showing the top mat component 148 shown in FIGS. 10 and 11 being aligned with and joined with the bottom mat component 158 shown in FIGS. 12 and 13. It will be appreciated that by placing the top mat component 148 and the bottom mat component 158 into the cold molding system 10 shown in FIG. 1 in the illustrated relative orientations, that the top mat component 148 may be joined to the bottom mat component 158 to form a construction mat quadrant 168.

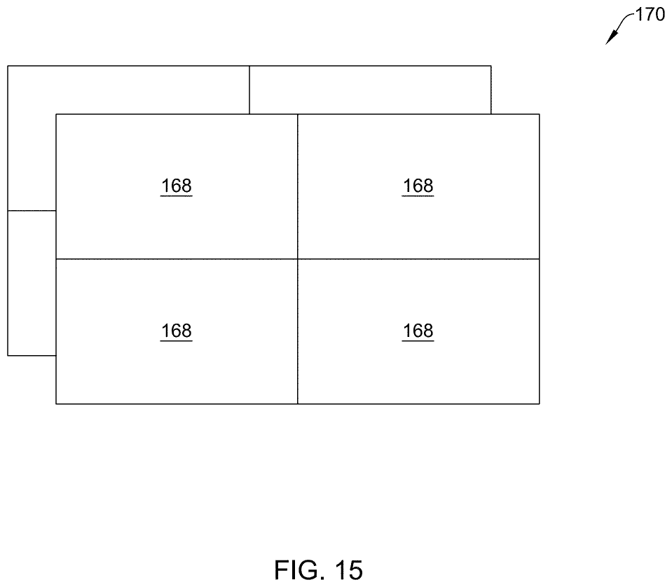

FIG. 15 is a schematic top view of an illustrative construction mat 170. The construction mat 170 may be formed by assembling together a total of four construction mat quadrants 166 that were each formed from a top mat component 148 and a bottom mat component 158 via the cold molding process described herein. The construction mat quadrants 168 may be secured together via the flanges 156/166 using any suitable fastening techniques and methods.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A method of molding a polymeric structure including a first polymeric component and a second polymeric component, the first polymeric component including a first mating surface and an opposing first free surface and the second polymeric component including a second mating surface and an opposing second free surface, the method comprising:
positioning the first polymeric component and the second polymeric component with the first mating surface facing the second mating surface;
disposing a charge of molten polymer between the first mating surface and the second mating surface;
applying a compressive force to the first free surface of the first polymeric component and to the second free surface of the second polymeric component in order to secure the first polymeric component to the second polymeric component in order to form the polymeric structure.

2. The method of claim 1, wherein the first polymeric component is formed prior to manufacturing the polymeric structure and is at or close to ambient temperature when positioned relative to the second polymeric component.

3. The method of claim 1, wherein the second polymeric component is formed prior to manufacturing the polymeric structure and is at or close to ambient temperature when positioned relative to the first polymeric component.

4. The method of claim 1, wherein the compressive force to the first free surface of the first polymeric component and to the second free surface of the second polymeric component is maintained until the charge of molten polymer solidifies.

5. The method of claim 1, further comprising:
forming a channel within at least one of the first mating surface and the second mating surface; and
disposing the charge of molten polymer between the first mating surface and the second mating surface comprises disposing the charge of molten polymer into the channel.

6. The method of claim 5, wherein forming a channel comprises forming a first channel portion in the first mating surface and a corresponding second channel portion in the second mating surface; and
wherein disposing the charge of molten polymer between the first mating surface and the second mating surface comprises disposing the charge of molten polymer into the first channel portion and into the second channel portion.

7. The method of claim 6, wherein the first channel portion and the second channel portion are configured such that the molten polymer, once solidified, forms a locking member within the first channel portion and the second channel portion that secures the first polymeric component to the second polymeric component.

8. The method of claim 1, wherein applying a compressive force to the first free surface of the first polymeric component and to the second free surface of the second polymeric component comprises applying a compressive force without applying any heat apart from residual heat from the charge of molten polymer.

9. The method of claim 1, wherein:
the first mating surface comprises first component mating features; and
the second mating surface comprises second component mating features that are complementary to the first component mating features; and
the first component mating features mate with the second component mating features when the first polymeric component and the second polymeric component are positioned with the first mating surface facing the second mating surface.

10. The method of claim 1, wherein the polymeric structure comprises a construction mat quadrant.

11. The method of claim 10, wherein the first polymeric component comprises a top half of the construction mat quadrant and the second polymeric component comprises a bottom half of the construction mat quadrant.

12. The method of claim 10, wherein the first polymeric component and the second polymeric component are each configured to include additional features that allow the construction mat quadrant to be secured to other construction mat quadrants to form a construction mat.

13. A construction mat quadrant, comprising:
an injection molded top mat component including a first mating surface;
an injection molded bottom mat component including a second mating surface in opposition with the first mating surface;
a first locking channel formed within the first mating surface;
a second locking channel formed within the second mating surface;
a polymeric locking member extending through the first locking channel and the second locking channel, the polymeric locking member preventing the top mat component from moving relative to the bottom mat component.

14. The construction mat quadrant of claim 13, wherein the first mating surface comprises a plurality of first mating features.

15. The construction mat quadrant of claim 14, wherein the second mating surface comprises a plurality of second mating features that are configured to accommodate the plurality of first mating features.

16. The construction mat quadrant of claim 15, wherein the plurality of first mating features engage with the plurality of second mating features in order to help secure the injection molded top mat component to the injection molded bottom mat component.

17. A construction mat, comprising:
four construction mat quadrants secured together, each of the four construction mat quadrants including:
an injection molded top mat component including a first mating surface;
an injection molded bottom mat component including a second mating surface in opposition with the first mating surface;
a first locking channel formed within the first mating surface;
a second locking channel formed within the second mating surface;
a polymeric locking member extending through the first locking channel and the second locking channel, the polymeric locking member preventing the top mat component from moving relative to the bottom mat component.

18. The construction mat of claim 17, wherein for each construction mat quadrant, the corresponding first mating surface comprises a plurality of first mating features.

19. The construction mat of claim 18, wherein for each construction mat quadrant, the second mating surface comprises a plurality of second mating features that are configured to accommodate the plurality of first mating features.

20. The construction mat of claim 19, wherein for each construction mat quadrant, the plurality of first mating features engage with the plurality of second mating features in order to help secure the injection molded top mat component to the injection molded bottom mat component.
